(19) United States
(12) Patent Application Publication
(10) Pub. No.: US 2006/0150106 A1
(43) Pub. Date: Jul. 6, 2006

(54) Mobile communication terminal

(76) Inventors: Paivi Jokinen, Tampere (FI); Nina Maki, Pirkkala (FI); Sanna M. Koskinen, Tampere (FI)

Correspondence Address: PERMAN & GREEN, 425 POST ROAD, FAIRFIELD, CT, 06824, US

(21) Appl. No.: 11/026,142

(22) Filed: Dec. 30, 2004

(51) Int. Cl. G06F 9/00

(52) U.S. Cl. 715/744

(57) ABSTRACT

A mobile communication terminal having a display, a memory arranged to store zero or more digital notes items, a controller and a digital notes application. The digital notes application is arranged to handle, via said controller, at least one of said digital notes items. A presence of a digital note item in said memory is visually indicated by a graphical representation on said display.

### TECHNICAL FIELD

The present invention relates to mobile communication terminals and in particular to mobile communication terminals having two displays.

### BACKGROUND OF THE INVENTION

The Nokia 9210™ communicator has a notes application by which the user can make short notes and save them in the Desk application view. The notes can be shown as icons resembling Post-it™ notes. When the user wants to view his notes he has to take out his communicator, preferably put it on some flat surface, like a table top, unfold the communicator, open the Desk view, scroll through his notes using the big four-way navigation key adjacent the QWERTY keypad on the bottom right-hand corner of the keypad block of the communicator and open a selected note by using either the Enter key or the uppermost one of the four keys adjacent the display.

Sometimes the step of changing the current view takes time, and as even small delays can be very irritating and stressing to people, that are in a hurry, it is a disadvantage to have to switch views back and forth.

Accessing ones notes as described above requires that the user uses either both hands or a surface and this can be awkward or perhaps impossible at a given moment.

Further, as the big screen has to be powered up it also consumes power and power consumption have become one of the most important features for mobile communication terminals and one of the strongest selling points.

As the notes are primarily intended to be used for easy access and not to limit the usefulness of the terminal the contemporary notes features have many drawbacks as described above.

### SUMMARY OF THE INVENTION

Generally, the above objectives are achieved by the attached independent patent claim.

An aspect of the invention is a mobile terminal comprising a display, a memory arranged to store zero or more digital notes items, a controller, a digital notes application arranged to handle, via said controller, at least one of said digital notes items wherein a presence of a digital notes item in said memory is visually indicated by a graphical representation on said display.

By having a visual indication of the notes the user is able to quickly ascertain whether he has notes or not and if so what they are about all in a quick and easy to use way.

Alternatively the terminal comprises a two-display user interface with a first inner display and a second outer display and in which said second outer display is used to present the graphical represetations.

By displaying the notes' graphical representations on the outer display it is much more easy to see them as one is not forced to unfold the terminal, thus making the browsing even more fast and efficient.

Further the terminal could also be arranged to display the graphical representation displayed when the terminal is in a idle mode, and is dependant on the number of digital notes stored in said memory, wherein no notes stored has a graphical representation of no icon visible,

one digital note item stored has the graphical representation of said icon being visible and

more than one digital note item stored has the graphical representation of said icon with a number indicating the number of notes.

This makes it possible for the user to quickly find out if he has any notes and if so, how many, increasing the easiness by which the terminal can be used.

Further, if each digital note items has a text and the graphical representation of a digital note comprises an at least partial printout of the text the user is able to quickly see what he has written notes about which is often enough for a user to remember the whole note.

Alternatively, the mobile communication terminal has graphical representations of all of the zero or more digital notes that are arranged to be displayed one at a time and a key comprised in the terminal is arranged, upon being depressed, to instruct said controller to switch the graphical representation currently being displayed the. This makes it very easy for a user to access and browse his notes using only one hand and with as few keypresses as possible.

Alternatively the graphical representation is arranged to carry an identification number identifying at least one digital note item and the text of the digital note item is arranged to be displayed on the display upon depression of a key comprised in the mobile communication terminal, said key corresponding to the number identifying the digital note. This makes it easy for a user to find his way among his notes and also allows him to quickly access one specific note without having to browse through them all.

Alternatively the graphical representation includes a list composed of at least a part of the text of at least one of the zero or more digital notes. This provides the user with a full overview of the notes and also what they are about and thus provides an easy to use and quick tool for remembering important data.

Further the display has a size and the graphical representation has a size and the size of the graphical representation is slightly smaller than the size of the display. This adds to the usability of the terminal as more of the note can be visible to the user at a time thus making it quicker to use.

Alternatively the digital notes items are arranged to be provided by a digital calendar application also stored in said memory. This further helæps the user remember things as important calendar events are also added to the noted for quick and easy browsing.

Further the digital notes application is arranged to be started via one of: the following arrangements:

via a menu associated with a softkey,

via a softkey directly or

via a shortcut thus making the arrangement even more easy to use and also offering posibilities for more versatile usage.

Alternatively, the mobile communication terminal has a menu list of at least one option, which list is associated with a softkey and which options are selectable via said softkey for performing at least one of the following actions on the digital notes items:

add new,

delete,

edit,

send,

copy or

mark relevance, by setting a relevance indicator for at least one of said zero or more digital notes items. This adds too the funtionality and therefore to the usability of the termanil without adding to the complexity of use of it.

Further the digital notes items have a relevance indicator and the digital notes items are displayed via the graphical representation in order according to their relevance indicator which helps the user arrange his notes after their importance thus speeding upo the browsing procedure as the not-so-important notes are sorted at the back and one does not have to scroll through them looking for the important ones.

Alternatively the digital notes application is arranged to provide a background image for said display, said background image comprising one of the following: a graphical representation of a digital note item or a specified background image. As it is prooven to be popular for users to personalise there equipment in various ways this adds a personal touch to the terminal and also makes the termonal easier to identify among other similar terminals.

Further the specified background image is user specified which further adds to the user friendliness of the terminal.

A termianl as described above has the benefits that it saves time and is easier to use and to display the notes, especially when implemented in an external screen like for example in a two-display user interface. Also, a terminal as above with two displays saves power as the large dislay does not have to power up simply to view the notes.s

### SHORT DESCRIPTION OF THE DRAWINGS

FIG. 1 schematically illustrates a functional block diagram of a mobile communication terminal according to an embodiment of the present invention.

FIG. 2 shows a schematic view of a mobile communication terminal with an example of a screenshot of a notes application according to the present invention.

FIG. 3 shows another schematic view of a mobile communication terminal with an example of a screenshot of a notes application according to the present invention.

### DETAILED DESCRIPTION OF THE EMBODIMENTS OF THE PRESENT INVENTION

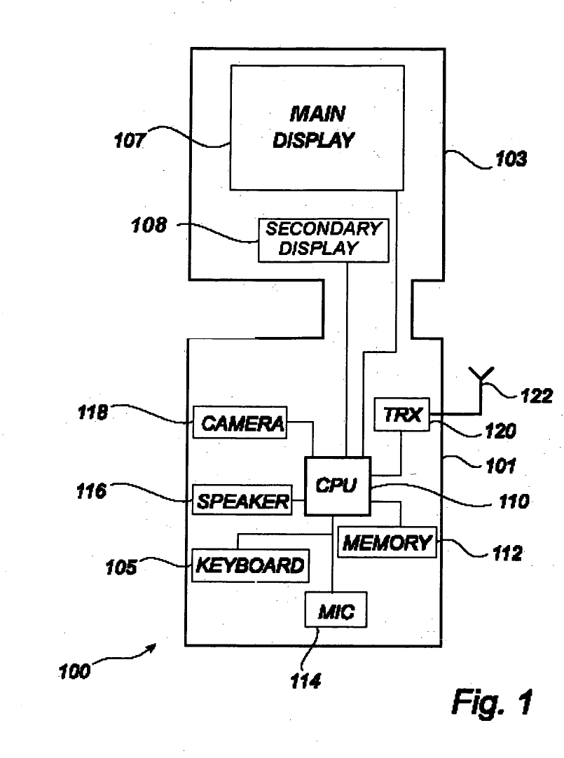

FIG. 1 shows a block diagram of a mobile communication terminal in the form of a telephone 100 according to the present invention. A first body part 101 comprises a processing unit 110 connected to an antenna 122 via a transceiver 120, a memory unit 112, a microphone 114, a keyboard 105, a speaker 116 and a camera 118. The processing unit 110 is also connected to a main display 107 and a secondary display 108, which are comprised in a second body part 103 of the telephone 100. The two body parts 101 and 103 are foldably hinged together so that they can either be in a closed position or an open position. The main display 107 and the secondary display 108 are most commonly positioned on either side of the body part 103. The secondary display 108 is visible even when the two body parts 101 and 103 are folded together, ie the telephone is closed. It is thus an outer display. The size of the secondary display 108 is smaller than the size of the main display 107 and the secondary display 108 requires less power to start up and keep active.

No detailed description will be presented regarding the specific functions of the different blocks of the telephone 100. In short, however, as the person skilled in the art will realize, the processing unit 110 controls the overall function of the functional blocks in that it is capable of receiving input from the keyboard 105, audio information via the microphone 114, images via the camera 118 and receive suitably encoded and modulated data via the antenna 122 and transceiver 120. The processing unit 110 is also capable of providing output in the form of sound via the speaker 116, images via the displays 107 add 108 and suitably encoded and modulated data via the transdeiver 120 and antenna 122.

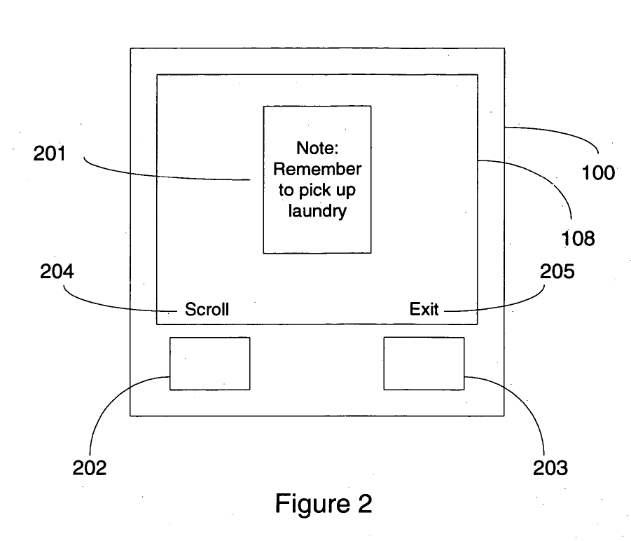

One embodiment according to the present invention will now be described with reference to FIGS. 1 and 2. In the memory 112 of the mobile communication terminal 100 a Notes application is stored along with a number of digital notes items (zero to as many as the memory can store) each having a text. The Notes application is not active while the phone is in idle mode, but can be activated or started through a menu of options available via a softkey 202 or 203, that is positioned adjacent the display, through a shortcut or via a softkey 202, 203 directly. When the Notes application is started either a starting image or the first digital notes item's text is displayed in a notes display window 201 on the secondary display 108. The starting image could for example show a picture of a notepad. This arrangement provides a graphical representation of the notes item and its text. Below the notes window 201 there are two softkey text labels 204 and 205 that inform the user of the current functions of the two softkeys 202 and 203, that are placed adjacent to, possibly below as in FIG. 2, the display 108. If the user would like to view some other notes he has made previously he only needs to press the left soft key 202 with the label 204 “Scroll” and a new user made note will be displayed in the notes display window 201.

This arrangement can easily be perceived to be the equivalent of having a virtual notepad. The user picks it up and scrolls through the pages looking for the wanted text and the arrangement described above would thus be easy and intuitive to learn for a user.

If the user wants to hide his notes he can either scroll to the starting image, if there is one, or exit the Notes application by pressing the right softkey 203. Naturally the Exit function could be exchanged for a Hide functionality only hiding the notes application and not ending it completely.

More options could also be added to either of the soft keys 202 or 203 or to a third soft key (not shown) which would enable the user to go in and edit a note or add a new note from the easy to access user interface. It could also be possible to send the note via SMS or email, to mark the note as having a special importance or relevance and to copy the note, either to a new note or to another application also stored in he memory. Marking the note as having a special importance can be done by using a relevance indicator such as a field or flag marking the note as important, unimportant or in between. Other ratings of importance or relevance are also possible.

Alternatively, these could be a small page indicator in a corner of the display window indicating how many pages or notes there are and what page is currently being browsed. For example if there were five notes and the third note was curently displayed the text “3(5)” could be displayed in the upper right-hand corner of the notes display window 201.

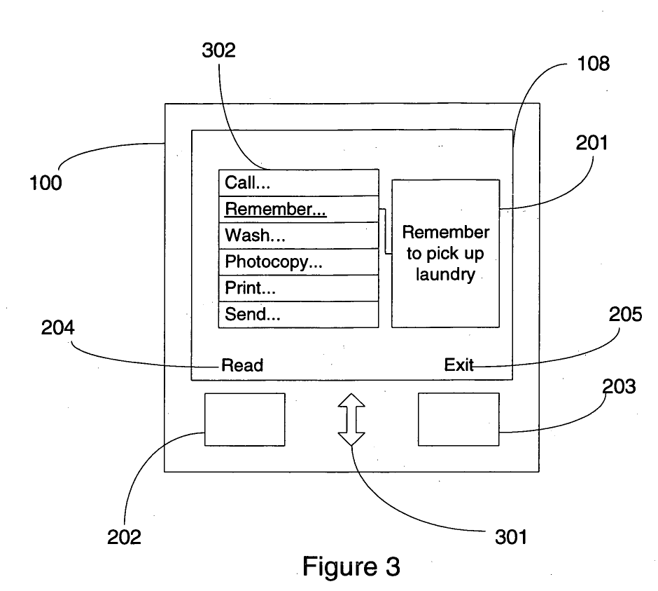

The various notes items in the Notes application could also be scrolled through by having one or more scroll keys 301 (see FIG. 3) on the terminal close to the display 108. This would provide the user the opportunity of having the option list available on the left soft key 202 for easy editing or adding of notes. The option list would contain options that the user could choose from and these could be add, edit, delete, mark as important etc. Notes marked as important could be placed so that they are always on top when the application is started and will thus be the first one the user sees.

It should be understood that the relative sizes of the secondary display 108 and the notes display window 201 are not necessarily to scale in FIG. 2. In fact the notes display window 201 could be made almost the same size as the secondary display 108 only leaving room for the text labels 204 and 205. It is also possible to exclude the text labels 204, 205 of the softkeys 202, 203 thus allowing a greater size for the notes display window 201. The size of the notes display window 201 is thus just slightly smaller than the size of the secondary display 108. As most notes will be rather short only a small notes display window 201 would be necessary and the arrangement is therefor well suited for use on small displays such as the secondary display 108.

The Notes application need not be closed when the phone is in idle mode or when a commonly known feature of a keylock is engaged. The Notes application could be run as a background application and the notes could be used as a background image. The optional starting image mentioned above would then be a user defined image, much like the common wallpaper of contemporary mobile telephones.

In an alternative embodiment, the notes items could be displayed as a list 302, see FIG. 3, with only their titles or starting words visible and the user could scroll through the list using a scroll key 301. The user could then select which notes that should be displayed by scrolling to that note, which note would be highlighted or as in FIG. 3 underlined, and choose to read it by pressing a softkey 202. The text for that note item would then be displayed in a note window 201.

Alternatively the note currently highlighted could automatically be displayed in the notes display window 201 as the user scrolls through the list and thus providing the option list to the softkey 202 otherwise used for opening the notes item.

Using a softkey for opening the notes item has the advantage of increasing the user's integrity as the notes are not shown as they are scrolled through.

Automatically showing the items as they are scrolled through have the advantage of being faster and requiring less key presses and finger movements.

By having a four way (up, down, left and right) scrollkey the user could use two directions (up and down) to scroll the list and the other two directions (left and right) to open and close the notes item.

In a further alternative embodiment the list of notes could also display a specific identification number for the notes and the user could open a specific note by typing in its identification number using a standard ITU-T keypad (not shown). This would work best for up to 9 notes items as the notes items would then have identification numbers that corresponded to the keys on the keypad, providing an easy and intuitive way for the user to select what notes item to view.

Other text items than notes could also be shown in this way. For example a calendar application also stored in the memory 112 could create notes to indicate that a calendar event is about to occur or have already occurred. Missed events could be marked in a different way perhaps using colors or blinking effects to better attract the users attention to the note.

To indicate to a user that there are notes or a note stored in the memory 112 of the terminal 100 a small icon or other graphical indication could be displayed in the display 108. This icon could further carry a number indicating how many notes that are stored in the memory 112. This graphical indication is a part of the graphical presentation of the digital notes.

The various embodiments described above all have the advantages of providing a fast and easy to use as well as intuitive way of browsing or scrolling through user notes using only a small, display and a limited number of input means. The user simply picks up his terminal, quickly opens the notes application, if not already opened, and scrolls through his notes, quickly and easily by using only a minimum of keypress and finger movements. The whole procedure can be done in one keypresses, or in fact less if the notes application should already be opened. And there is no need to unfold the terminal and the whole operation of browsing the notes are done using only one hand and very few finger movements.

It should be understood that the components above could all be exchanged for more graphically demanding objects. For example the option list could be substituted with an array of icons. resembling Post-it™ notes, the display window could bear the resemblance of a Post-it™ note and when scrolling through the notes item the graphics could be made to scroll through a pad of Post-it™ notes. Other alternatives to Post-it™ notes are Notepad images, pieces of papers with pins (as on noteboards) or magnets (as on refrigerator doors).

Although the invention has been described with regards to a mobile communications having two displays, the invention also finds merit in mobile communications terminals having only one display.

It should also be understood that any combination or variation of the embodiments described above are also part of the inventive concept of the present invention.

I/we hereby claim:

1. A mobile communication terminal comprising a display,
a memory arranged to store zero or more digital notes items,
a controller,
a digital notes application arranged to handle, via said controller, at least one of said digital notes items wherein a presence of a digital notes item in said memory is visually indicated by a graphical representation on said display.

2. A mobile communication terminal according to claim 1 comprising a two-display user itnerface with a first inner display and a second outer display and in which said display defined in claim 1 and said second outer display are the same display.

3. A mobile communication terminal according to claim 1 wherein said graphical representation is arranged to be displayed when the terminal is in a idle mode, and is dependant on the number of digital notes stored in said memory, wherein no notes stored has a graphical representation of no icon visible,
one digital note item stored has the graphical representation of said icon being visible and
more than one digital note item stored has the graphical representation of said icon with a number indicating the number of notes.

4. A mobile communication terminal according to claim 1 wherein each digital note item has a text and the graphical representation of a digital note comprises an at least partial printout of the text.

5. A mobile communication terminal according to claim 1 wherein the graphical representations of all of the zero or more digital notes are arranged to be displayed one at a time and a key comprised in the terminal is arranged, upon being depressed, to instruct said controller to switch the graphical representation currently being displayed.

6. A mobile communication terminal according to claim 4 wherein said graphical representation is arranged to carry an identification number identifying at least one digital note item and the text of the digital note item is arranged to be displayed on the display upon depression of a key comprised in the mobile communication terminal, said key corresponding to the number identifying the digital note.

7. A mobile communication terminal according to claim 6 wherein said graphical representation includes a list composed of at least a part of the text of at least one of the zero or more digital notes.

8. A mobile communication terminal according to claim 1 wherein the display has a size and the graphical representation has a size and the size of the graphical representation is slightly smaller than the size of the display.

9. A mobile communication terminal according to claim 1 wherein said digital notes items are arranged to be provided by a digital calendar application also stored in said memory.

10. A mobile communication terminal according to claim 1 wherein said digital notes application is arranged to be started via one of the following arrangements:
via a menu associated with a softkey,
via a softkey directly or
via a shortcut.

11. A mobile communication terminal according to claim 1 further comprising a menu list of at least one option, which list is associated with a softkey and which options are selectable via said softkey for performing at least one of the following actions on the digital notes items:
add new,
delete,
edit,
send,
copy or
mark relevance, by setting a relevance indicator for at least one of said zero or more digital notes items.

12. A mobile communication terminal according to claim 11 wherein digital notes items have a relevance indicator and the digital notes items are displayed via the graphical representation in order according to their relevance indicator.

13. A mobile communication terminal according to claim 1 wherein said digital notes application is arranged to provide a background image for said display, said background image comprising one of the following: a graphical representation of a digital note item or a specified background image.

14. A mobile communication terminal according to claim 13 wherein said specified background image is user specified.
